(19) United States
(12) Patent Application Publication
(10) Pub. No.: US 2018/0341743 A1
(43) Pub. Date: Nov. 29, 2018

(54) METHOD FOR DESIGNING AND DIMENSIONING A NEW PART OF A MOTOR VEHICLE

(71) Applicant: Technische Universität Darmstadt, Darmstadt (DE)

(72) Inventors: Stéphane Foulard, Rodgau (DE); Stephan Rinderknecht, Gomaringen (DE); Rafael Fietzek, Darmstadt (DE)

(73) Assignee: Technische Universität Darmstadt, Darmstadt (DE)

(21) Appl. No.: 15/777,676

(22) PCT Filed: Nov. 11, 2016
(86) PCT No.: PCT/EP2016/077485

§ 371 Date: May 21, 2018

(30) Foreign Application Priority Data
Nov. 19, 2015 (DE) 10 2015 120 107.0

(51) Int. Cl. G06F 17/50

(52) U.S. Cl. CPC G06F 17/5095; G06F 2217/14; G06F 2217/12; G06F 17/5086

(57) ABSTRACT

The invention relates to a method (1) for designing and dimensioning a new part (2) of a motor vehicle (3). All of the motor vehicles (5) of a motor vehicle fleet (6) have a reference part (4) with an identical structure, and the reference parts (4) and the new part (2) are of the same component type. Load spectra and damage levels of the reference parts of all the motor vehicles (5) of the motor vehicle fleet (6) are continuously ascertained on the basis of sensor and vehicle state information available in each motor vehicle (5) using specified algorithms. The load spectra and damage levels are stored in a central database (9). A reference stress on a component of the component type is ascertained regularly on the basis of the load spectra and damage levels provided in the central database (9) at a specific point in time for the reference parts (4) of all of the motor vehicles (5) of the vehicle fleet (6). The new part (2) is designed and dimensioned while taking into consideration the reference stress. The reference stress is less than the maximally occurring stress on all of the reference parts (4).

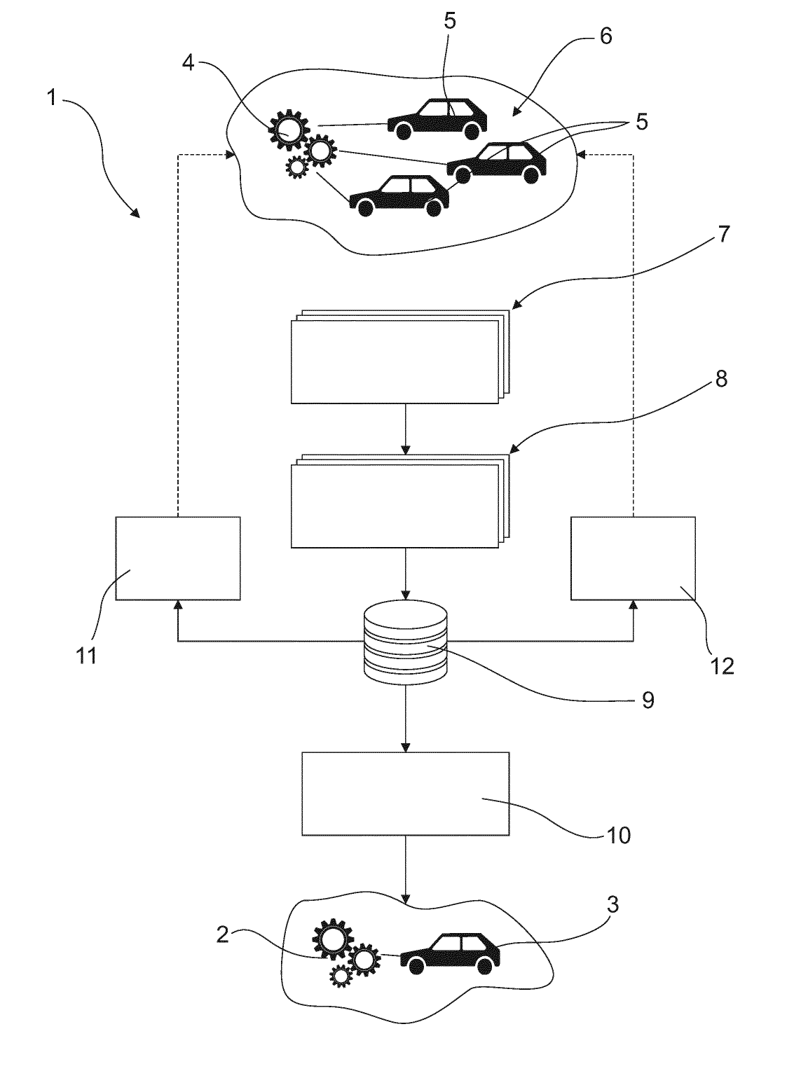

### TECHNICAL FIELD

The invention relates to a method for designing and dimensioning a new part of a motor vehicle.

### BACKGROUND

In the development of new motor vehicles, the various components of the motor vehicle to be developed are designed and dimensioned using known methods. In order to be able to ensure the functioning of the motor vehicle over its entire life, the new components are basically designed in such a way that they can withstand the stresses occurring in the life of the motor vehicle as well as wear and tear of components occurring in the life of the motor vehicle. For this purpose, usually test drives and computer simulations are performed in order to determine the presumed stress occurring during the life cycle of the new part, and to subsequently design the new part based upon these results.

An alternative method for the designing and dimensioning of a new part of a motor vehicle, in this case a gearbox to be developed, is described in patent document WO 2010/121 693 A1. In the method described in this document, load spectra of the gearbox are determined during operation of the vehicle based on various sensor information, and stored in a non-volatile memory. The load spectra determined over the life cycle of the gearbox and the motor vehicle, respectively, are used for the designing of the new gearbox then. In this way, it is possible to prevent an over-dimensioning of certain components of the gearbox to be developed, and to thereby achieve a reduction in weight without deteriorations in terms of function and strength. Another method for the determination of load spectra is described in the German patent application 10 2014 112 147.3.

In particular in view of the ever-shorter development cycles of the components of new motor vehicles, when employing this method, merely information about comparatively few gearboxes over their entire life cycle is available at the start of a new development. Although using this method, due to the small data resources available, an exact designing and dimensioning of the gearbox while avoiding a significant over-dimensioning of individual components of the gearbox is not possible.

The object of the invention is to prevent a usually necessary over-dimensioning of new parts, and moreover to enable further cost reductions by an adequate dimensioning and designing across all motor vehicles of a motor vehicle fleet.

### SUMMARY

This object is achieved by a method for designing and dimensioning a new part of a motor vehicle, wherein all motor vehicles of a motor vehicle fleet comprise an identically constructed reference part and the reference parts and the new part are of the same type of component, wherein load spectra and damage levels of the reference parts of all motor vehicles of the motor vehicle fleet are continuously determined based on sensor and driving condition information available in the respective motor vehicle using predetermined algorithms, and wherein the load spectra and damage levels are stored in a central database, wherein a reference stress of a component of the component type is regularly determined based on the load spectra and damage levels of the reference parts of all motor vehicles of the motor vehicle fleet available in the central database at a specific point in time, wherein the new part is designed and dimensioned under consideration of the reference stress, and wherein the reference stress is smaller than the maximum occurred stress of all reference parts. The method according to the invention therefore provides for continuous determination of load spectra and damage levels for each vehicle.

These load spectra and damage levels, which are available in the database no later than when commissioning first new motor vehicles of the motor vehicle fleet, can be used for designing and dimensioning of the new part still during the life of the examined reference part. For this purpose, using predetermined algorithms, the load spectra and damage levels available at the start of the development can be processed in order to determine the presumed stress on the reference components over the intended life cycle of the reference components. This reference stress can regularly be adjusted during the development process by load spectra and damage levels newly acquired during operation of the motor vehicles of the motor vehicle fleet, in order to further improve the dimensioning and designing of the new part. In this way, the new part can be designed and dimensioned based upon sufficiently large data resources. In the case that an individual reference part fails during operation of the respective motor vehicle, the occurred damage can be understood in a better way due to the available history of stress on this reference part, so that this information can be considered additionally in the design of the new part.

Advantageously, it is provided according to the invention that control units of all motor vehicles of the motor vehicle fleet continuously determine the load spectra and the damage levels of the reference parts based on the sensor and driving condition information available in the respective motor vehicle, and wherein the control units regularly transmit the determined load spectra and damage levels to the central database connected to the control units in a data-transmissive manner. Thus, the load spectra and damage levels are determined on corresponding control units—onboard—and transmitted to a central database using modern communication systems.

However, it is also possible and provided according to the invention that the control units of all motor vehicles of the motor vehicle fleet continuously determine sensor and driving condition information available in the respective motor vehicle and regularly transmit it to the central database connected to the control units in a data-transmissive manner, wherein the load spectra and the damage levels of the reference parts are determined based upon the sensor and driving condition information available in the central database. In this way, the determination of the load spectra and the damage levels can occur at a later point in time as required, wherein the computing capacity and the storage capacity required for the calculation of the predetermined algorithms does not have to be provided in the individual control units, but instead the load spectra and the damage levels can be calculated on correspondingly configured computers.

Apart from a more precise designing and dimensioning of the new part, the method according to the invention allows further reductions in weight, CO2 and costs by that the reference stress is determined in such a way that the reference stress is smaller than the maximum occurred stress of all reference parts. By this specification, the new part is deliberately designed in such a way that that the new part will not reach the intended life cycle in some loads to be expected in real operation, and must be replaced early. Such a replacement of components yet during the expected life cycle of the component is accepted only by the customers if, first, the respective component is advantageously replaced free of charge and, second, the replacement can be effected in the course of the regular maintenance. A reduction of costs and a resource-saving use of this new method is possible in that not all of the components must be replaced regularly in the scope of the maintenance, but instead that the motor vehicles in which the respective components is likely to fail in near future are determined based upon the determined load spectra and damage levels regularly transmitted to the central database. In this way, it is possible to design the new part for example to a standard driver, who presumably will have the new part stressed in an average manner, so that for example 90% of the new parts installed in the entire motor vehicle fleet will reach the intended life cycle and merely 10% of the new parts must be replaced before the elapse of the planned life cycle as a matter of precaution. In this case, the reference stress corresponds to the stress that maximally occurs in 90% of the different utilization profiles. The reference stress is often also referred to as the reference utilization profile.

In order to obtain a sufficient database for the new development as early as possible, and to be able to extend this database continuously, and to be able to replace reference parts which will presumably fail in the near future on time, it is provided according to the invention that the control units transmit the respectively determined sensor and driving condition information and/or the load spectra and damage levels to the database via wireless data connections. For this purpose, the already known methods and devices for wireless data transmission, for example via mobile communication networks and the like, can be used. In this way, in particular also for the development of new parts of motor vehicles in which new technologies such as the hybrid technology are used, information about the occurring stress are available early. In particular in the use of such new technologies, for which no or only few experience is present, the designing based upon the known methods by simulation and the like is difficult, so that a significant over-dimensioning of the individual new parts cannot be prevented according to the methods known from the prior art.

In order to further improve the designing and dimensioning, it is provided according to the invention that the control units transmit supplementary vehicle state parameters to the data base in addition to the load spectra and damage levels. These vehicle state parameters can be information about the respectively driven distances, the occurred environmental conditions, etc., which are determined through the various sensors provided in the motor vehicles and which are available.

Advantageously, it is provided according to the invention that the reference stress is determined in consideration of weight and cost models for the production of the new part and/or CO2 models for estimating the CO2 footprint generated by the new part and/or evaluation models for evaluating different operating strategies. In the weight and cost models, according to the invention, advantageously the development, material and production costs, the costs for the final customer, costs for replacing of the new part, etc. can be taken into account. According to the invention, in the models for estimating the CO2 footprint generated by the new part, the material used, the production method, the fuel consumption expected due to the weight of the new part to be transported, are taken into account. Advantageously, in the development of different operating strategies, for example the expected fuel consumption and expected life cycle of the new part can be taken into account. On the basis of these models or the parameters determined using these models, the reference stress of the new part to be developed can be determined with respect to the different objectives, which are in a conflict of objectives with one another, such as, inter alia, the reaching of cost reductions, a life cycle as long as possible, and a CO2 footprint as small as possible.

In a particularly advantageous configuration of the method according to the invention, it is provided that the reference stress is smaller than 95%, preferably smaller than 90%, and particularly advantageously smaller than 85% of the maximally occurred stress of all reference parts.

In particular also if at least individual new parts of the motor vehicle fleet have already been designed and dimensioned on the basis of the method according to the invention, it is provided according to the invention, that an individual reference part is replaced upon reaching a predetermined damage level limit. This replacement is advantageously effected at the expense of the manufacturer in the scope of the planned maintenance of the motor vehicle, so that the customer will not have any disadvantages resulting from the replacement.

However, it is also possible and provided according to the invention that an operating strategy of the motor vehicle is adjusted when reaching the damage level limit. In this way, a failure of the individual reference part can be prevented, so that the replacement can be effected in the scope of the regular maintenance and the vehicle does not have to be recalled to the workshop in an unscheduled manner. According to the invention, an adjustment of the operating strategy can alternatively occur early, before reaching the predetermined damage level limit. Such an early adjustment can be appropriate in particular if the determined load spectra and damage levels suggest a too fast increase of the actual damage and a minimum life cycle of the respective reference part cannot be reached without adjusting the operating strategy, for example.

The determined damage levels of the individual motor vehicles can also be used to determine a residual value of the respective motor vehicle. Furthermore, maintenance intervals of individual motor vehicles or of the entire motor vehicle fleet can be adjusted based upon the available damage levels.

In a particularly advantageous configuration of the method according to the invention, it is provided that based upon the load spectra and damage levels of the reference parts of all motor vehicles of the motor vehicle fleet available in the central database at a specific point in time, certain reference parts are selected and subsequently replaced based upon predetermined load spectra criteria and/or damage level criteria, in order to be able to examine the determined reference parts in more detail in laboratories. Based upon the always up-to-date information, available in the central database, about the different reference parts of the motor vehicles of the entire motor vehicle fleet, such reference parts that were subject to particular stress can be selected, in order to be able to examine the effects of these stresses on the respective reference part in detail. The information obtained thereby can in turn be used for the designing and dimensioning of the new part. Furthermore, the information determined in this way can be used, according to the invention, that algorithms used for the determination of the damage level and/or the load spectra criteria and/or the damage level criteria and/or the damage level limit can be adjusted based upon the performed examination.

According to the invention, it is advantageously provided that the damage level limit is regularly determined based upon the load spectra and damage levels of the reference parts of all motor vehicles of the motor vehicle fleet available in the central database at a specific point of time. Based upon the information about the new part determined in operation of the motor vehicle fleet, the previously determined damage level limit can be adjusted continuously, so that a most needs-based replacement of the reference parts of the motor vehicle fleet that have a high probability to fail within the next maintenance interval is achieved. An unnecessary replacement of reference parts can be prevented thereby, and the number of unnecessarily replaced reference parts can be lowered, respectively.

Further advantageous configurations of the method according to the invention are explained in more detail by means of an exemplary embodiment illustrated in the drawing.

### BRIEF DESCRIPTION OF THE DRAWING

The sole FIGURE shows a flow chart of a method for designing and dimensioning a new part of a motor vehicle.

### DETAILED DESCRIPTION

The drawing shows a schematically illustrated flow chart of the method 1 according to the invention for the designing and dimensioning of a new part 2 of a motor vehicle 3. For using the method 1 according to the invention, it is necessary to first develop suitable algorithms for online load spectra exchange and online damage level determination of reference parts 4, and to implement them on the respective control units of the motor vehicles 5 of the motor vehicle fleet 6. Using these algorithms, up-to-date load spectra, damage levels and, if appropriate, supplementary vehicle state parameters are determined in determination steps 7 performed on all motor vehicles, and transmitted to a central database 9 in a wireless manner in transmission steps 8. The determination steps 7 and transmission steps 8 performed for different motor vehicles 5 are not time-synchronized and occur independently from one another.

The information contained in the database 9 are subsequently used to design the new part 2 in a design step 10, and to determine a reference stress to that end. Moreover, this information is also used to replace individual reference parts 4 of certain motor vehicles 5 of the motor vehicle fleet 6, if it is determined in a damage level verification step 11 that a specific reference part 4 has reached a predetermined damage level limit. Finally, this information is used to determine, in a verification step 12, such reference parts 4 of individual motor vehicles 5 of the motor vehicle fleet 6 which fulfill the predetermined load spectra criteria and/or damage level criteria and which should therefore advantageously be replaced, in order to be able to carry out further examinations in a laboratory.

1. A method (1) for designing and dimensioning a new part (2) of a motor vehicle (3),
wherein all motor vehicles (5) of a motor vehicle fleet (6) comprise an identically constructed reference part (4) and the reference parts (4) and the new part (2) are of the same construction type,
wherein load spectra and damage levels of the reference parts of all motor vehicles (5) of the motor vehicle fleet (6) are continuously determined based on sensor and driving condition information available in the respective motor vehicle (5) using predetermined algorithms, and
wherein the load spectra and damage levels are stored in a central database (9),
wherein a reference stress of a component of the component type is regularly determined based on the load spectra and damage levels of the reference parts (4) of all motor vehicles (5) of the motor vehicle fleet (6) available in the central database (9) at a specific point in time,
wherein the new part (2) is designed and dimensioned under consideration of the reference stress, and
wherein the reference stress is smaller than the maximum occurred stress of all reference parts (4).

2. The method (1) according to claim 1,
wherein control units of all motor vehicles (5) of the motor vehicle fleet (6) continuously determine the load spectra and the damage levels of the reference parts based on sensor and driving condition information available in the respective motor vehicle (5), and
wherein the control units regularly transmit the respectively determined load spectra and damage levels to the central database (9), which is connected to the control units in a data-transmissive manner.

3. The method (1) according to claim 1,
wherein control units of all motor vehicles (5) of the motor vehicle fleet (6) continuously determine sensor and driving condition information available in the respective motor vehicle (5) and regularly transmit it to the central database (9) connected to the control units in a data-transmissive manner,
wherein the load spectra and the damage levels of the reference parts are determined based on the sensor and driving condition information available in the central database (9).

4. The method (1) according to claim 2,
wherein the control units transmit the respectively determined sensor and driving condition information and/or the load spectra and damage levels via wireless data connections to the database (9).

5. The method (1) according to claim 2,
wherein the control units transmit supplementary vehicle state parameters to the database (9) in addition to the load spectra and damage levels.

6. The method (1) according to claim 1,
wherein the reference stress is determined under consideration of weight and cost models for the production of the new part (2) and/or CO2 models for estimating a CO2 footprint generated by the new part (2) and/or evaluation models for evaluating different operating strategies.

7. The method (1) according to claim 1,
wherein the reference stress is smaller than 95% of the maximum occurred stress of all reference parts (4).

8. The method (1) according to claim 1,
wherein an individual reference part (4) is replaced when reaching a predetermined damage level limit.

9. The method (1) according to claim 1,
wherein an operating strategy of the motor vehicle (5) is adjusted when reaching a predetermined damage level limit.

10. The method (1) according to claim 8,
wherein the damage level limit is re-determined regularly based on the load spectra and damage levels of the reference parts (4) of all motor vehicles (5) of the motor vehicle fleet (6) available in the central database (9) at a specific point in time.

11. The method (1) according to claim 1,
wherein based on the load spectra and damage levels of the reference parts (4) of all motor vehicles (5) of the motor vehicle fleet (6) available in the central database (9) at a specific point of time, certain reference parts (4) are determined and subsequently replaced on the basis of predetermined load spectra criteria and/or damage level criteria, in order to be able to examine the certain reference parts (4) in more detail in laboratories.

12. The method (1) according to claim 11,
wherein algorithms used for determining the damage level and/or the load spectra criteria and/or the damage level criteria and/or the damage level limit is/are adjusted on the basis of the performed examination of the replaced reference parts (4).

13. The method (1) according to claim 9,
wherein the damage level limit is re-determined regularly based on the load spectra and damage levels of the reference parts (4) of all motor vehicles (5) of the motor vehicle fleet (6) available in the central database (9) at a specific point in time.

14. The method (1) according to claim 1
wherein the reference stress is smaller than 90% of the maximum occurred stress of all reference parts (4).

15. The method (1) according to claim 1
wherein the reference stress is smaller than 85% of the maximum occurred stress of all reference parts (4).
